(19) United States
(12) Patent Application Publication
(10) Pub. No.: US 2014/0218947 A1
(43) Pub. Date: Aug. 7, 2014

(54) TRAVELING DIRECTION ASSISTANCE GUIDANCE SYSTEM FOR VEHICLE

(71) Applicant: YU-CHUAN LEE, Xing Chu (TW)

(72) Inventor: YU-CHUAN LEE, Xing Chu (TW)

(21) Appl. No.: 14/080,427

(22) Filed: Nov. 14, 2013

(30) Foreign Application Priority Data
Feb. 7, 2013 (CN) 201310050063.3

(51) Int. Cl. B60Q 1/12

(52) U.S. Cl. CPC B60Q 1/12
USPC 362/466; 362/465

(57) ABSTRACT

A traveling direction assistance guidance system mounted on a vehicle which compromising at least a light source, a sensing module for sensing the vehicle traveling direction and a light control apparatus. Based on the vehicle traveling direction sensed by the sensing module and other external control signals, the light control apparatus adjusts the light beams of the light source as the light beams associated with the vehicle traveling directions. When the vehicle travels straight, the light beam is adjusted as a straight line guide light beam. When the vehicle turns, the light beam is adjusted as a curved guide light beam, and the direction and curve of the guide light beams changes over the rotational angle of the steering wheel. Hence, allows the driver to know the expected traveling trajectories when the vehicle is traveling straight or turning, and thus effectively protecting the driving safety.

### BACKGROUND OF INVENTION

1. Field of the Invention

The present invention relates generally to a vehicle guidance system, and more particularly to a traveling direction assistance guidance system which can project straight beam or curved arc beam when the vehicle travels straight or turns around respectively.

2. Description of Related Art

The general night driving safety design for vehicle is the installation of projection lights in front of the vehicle and warning lights in the rear of the vehicle; when traveling at night, through the projection lights in front of the vehicle, the driver can see a large range of vision in front of the vehicle. However, since the projection lights are for the illumination of the large range of vision of the vehicle, they cannot exactly mark the actual trajectory of the vehicle in the forward direction; the rear warning lights are for warning and the vision of them is much more unclear as compared with the projection lights. Hence, the backward direction of the vehicle trajectory cannot be determined through the rear warning lights.

Although the existing vehicle guidance technologies use cameras to film the direction of travel of the vehicle and display the vehicle's direction of travel by the image displayed on the vehicle display panel, the driver needs to shift attention to the display panel and cannot directly learn the expected traveling trajectories in the straight traveling and turning around of the vehicle.

### SUMMARY OF THE INVENTION

The primary objective of the present invention is to provide a traveling direction assistance guidance system that can solve the aforementioned problems.

The present invention of the traveling direction assistance guidance system is installed on a vehicle, and the traveling direction assistance guidance system comprises at least one light source, a sensing module sensing the vehicle traveling direction and a light control apparatus. The light control apparatus, based on the sensed vehicle traveling direction of the sensing module and other external control signals, adjusts the light beam of the light source as a variety of patterns of guide light beam associated with the traveling direction of the vehicle. When the vehicle is traveling straight, light beam is adjusted and adjusted as a straight line guide light beam. When the vehicle turns, the light beam is adjusted and adjusted as a curved arc guide beam, which can change over the vehicle's turning angles in direction and curvature.

Preferably, said vehicle comprises a steering wheel adjusting the traveling direction, wherein: said sensing module is a sensor detecting the rotation angle of the steering wheel or its linking device.

Preferably, said light control apparatus comprises a control unit and a memory unit. The control unit can adjust the light beam of the light source as a variety of patterns of guide light beam associated with the traveling direction of the vehicle based on the steering angle sensed by the sensing module and other external control signals coupled with control command and data recorded in the memory unit. Said external control signals comprise the driver's selection of guide light beam types, or output signals of other devices for controlling the changes in the pattern of guide light beams.

Preferably, said control commands and data pre-stored in the memory unit comprise: a mapping table of steering angle corresponding to the direction and curvature of the projection beam, a mapping table of traveling speed corresponding to the length and color of the projection beam, a command to control light beam pattern or a code of controlling light beam pattern. Said commands to control light beam pattern comprise: a light source color selection command, a light source luminance control command, a linear or planar light beam selection command, a projection angle compensation command, a light beam end pattern command, or a projected image data or X-Y coordinate data.

Preferably, said light control apparatus comprises at least one lens and a control unit. The control unit can adjust the light beam of the light source as a variety of patterns of guide light beam associated with the traveling direction of the vehicle based on the steering angle sensed by the sensing module and other external control signals. When the vehicle travels straight forward, the control unit can control the light beam going through the lens into a straight line guide light beam through a part of the lens. When the vehicle turns, the light beam of the light source can be adjusted into guide beams of various curvatures after going through different parts of the lens.

Preferably, said lens is designed as a lens of curvature or a lens of the refractive index gradually changes from the lower layer to the upper layer according to the optical principles, so that the incident light beam will be different in horizontal deflection in the upper and lower layers, showing a curved arc guiding light beams; when the curvature or refractive index differences of the upper and lower layers of the lens are greater, the adjusted light beam curvature will be greater. The differences vary at different parts of the lens. When the turning angle of the vehicle is greater, the adjustment is made through the part of greater difference.

Preferably, said lens is a lens of a variety of curvatures or the refractive indices, or a plurality of lens components of different curvatures or refractive indices. Among the assembly of lenses, a lens is to adjust the straight line guide light beam and the rest lens components adjust the curved guide light beams of different curvatures.

The present invention of a traveling direction assistance guidance system has the following advantages: when the vehicle is in motion, through the light control apparatus of the present invention, the light beam of the light source is adjusted into a straight line or curved guide light beam associated with the vehicle traveling direction. Hence, it allows the driver to clearly know the expected traveling trajectories when the vehicle is traveling straight and turning, and thus effectively protecting the driving safety.

### BRIEF DESCRIPTION OF THE DRAWINGS

FIG. 1 is the block diagram of the present invention of a traveling direction assistance guidance system;

FIG. 2 is the diagram illustrating the present invention of a traveling direction assistance guidance system installed on a vehicle;

FIG. 3 is the block diagram illustrating the embodiment of the present invention of a traveling direction assistance guidance system; the straight/curved guide light beam is associated with the rotation angle of the steering wheel;

FIG. 4 is another block diagram illustrating the embodiment of the present invention of a traveling direction assistance guidance system, its light control apparatus has a lens to adjust the light beams of the light source into straight line light beams or light beams of various curvatures;

FIG. 5 is the three-dimensional diagram of the lens of the present invention of a traveling direction assistance guidance system;

FIG. 6 is the cross-sectional diagram of the upper parts of the lens as shown in FIG. 5;

FIG. 7 is the cross-sectional diagram of the lower parts of the lens as shown in FIG. 5.

### DETAILED DESCRIPTION OF THE INVENTION

The present invention is elaborated as follows with the accompanying diagrams and embodiment. Before the detailed description of the present invention, it should be noted that similar components of the following two relatively better embodiments of the present invention are assigned with the same reference numbers.

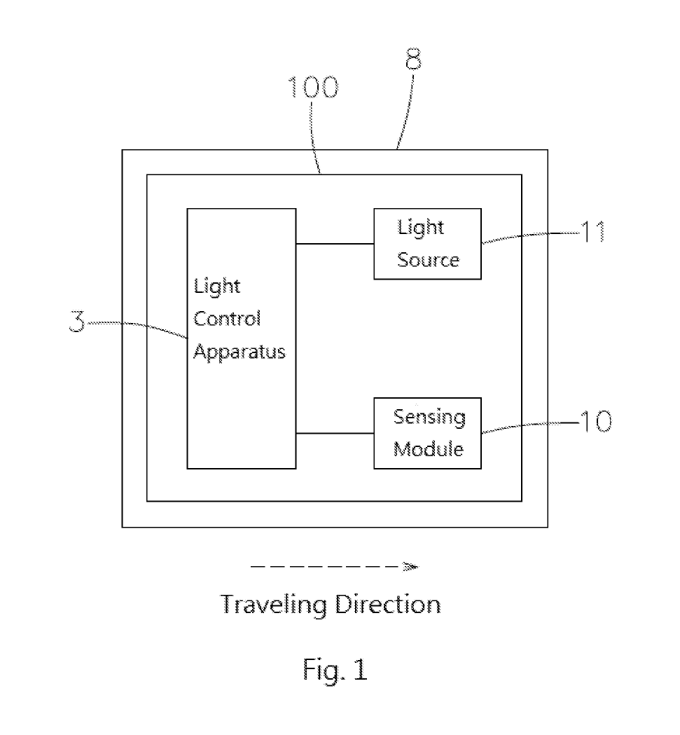

As shown in FIG. 1, the present invention of a traveling direction assistance guidance system 100 is mounted on a vehicle 8. The traveling direction assistance guidance system 100 comprises at least one light source 11 that generates light, a sensing module 10 that senses the traveling direction of the vehicle 8, and a light control apparatus 3. The light control apparatus 3, based on the sensed traveling direction of vehicle 8 by the sensing module 10 or other external control signals, can adjust the light beams of the light source 11 as a variety of guide light beams associated with the traveling directions of vehicle 8. When vehicle 8 travels straight, the light beam of the light source 11 can be adjusted into a straight line guide light beam. When the vehicle 8 turns, it can adjust the light beam of light source 11 into a curved guide light beam.

Examples of the external control signals comprise: the driver's selection of the guide light beam types or the output signals of other devices; external control signals can be used to control the change in the patterns of the guide light beams including the turning on and off the light sources of different colors, control of light source illumination, turning on the linear or planar light beam, projection angle compensation, the light beam end pattern, etc.

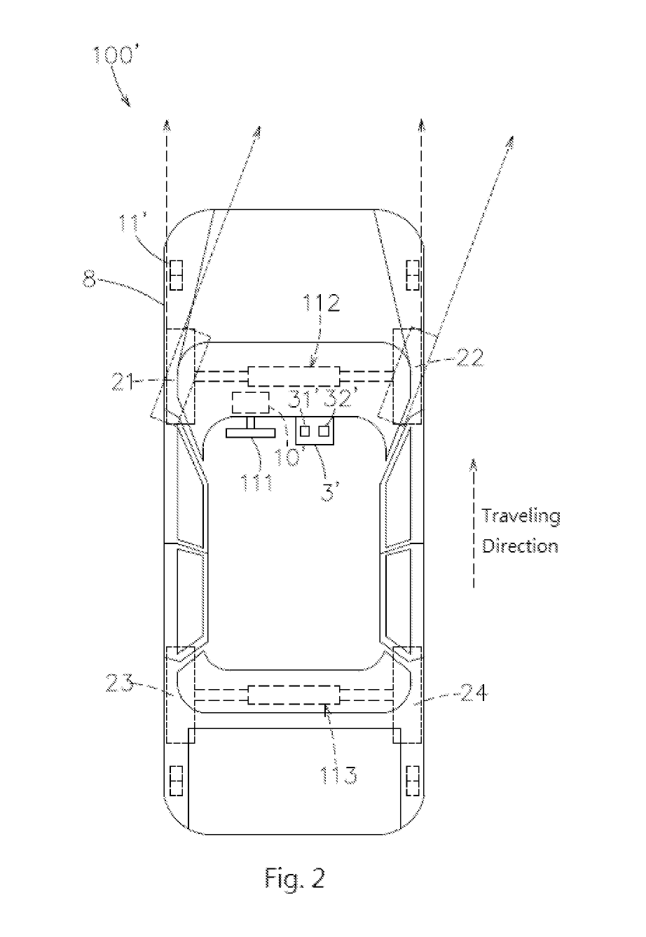

As shown in FIG. 2, in an embodiment of the present invention, the traveling direction assistance guidance system 100′ is mounted on a vehicle 8, traveling direction assistance guidance system 100′ comprises a light source 11′ that generates light, a sensing module 10′ that senses the traveling direction of the vehicle 8, and a light control apparatus 3′ that links the sensing module 10′ and light source 11′.

Vehicle 8 comprises of a steering wheel 111, the front wheels 21, 22, the rear wheels 23, 24, a front drive module 112 driving front wheels 21, 22 or a rear drive module 113 driving the rear wheels 23, 24; when vehicle 8 uses the front drive module 112 to turn around, the rotation of the steering wheel 111 can drive the front drive module 112 to rotate the front wheels 21, 22 upon the axis of the vehicle 8. When the vehicle 8 uses the rear drive module 113 to turn around, the rotation of the steering wheel 111 can drive the rear drive module 113 to rotate the rear wheels 23, 24 upon the axis of vehicle 8; hence, the steering wheel 111, front drive module 112 and rear drive module 113 are all used to adjust the traveling direction of the vehicle 8. The sensing module 10′ is a sensor to detect the rotation angles of the steering wheel 111, front drive module 112, rear drive module 113, and wheels 21, 22, 23, 24 or devices linked with the aforementioned components.

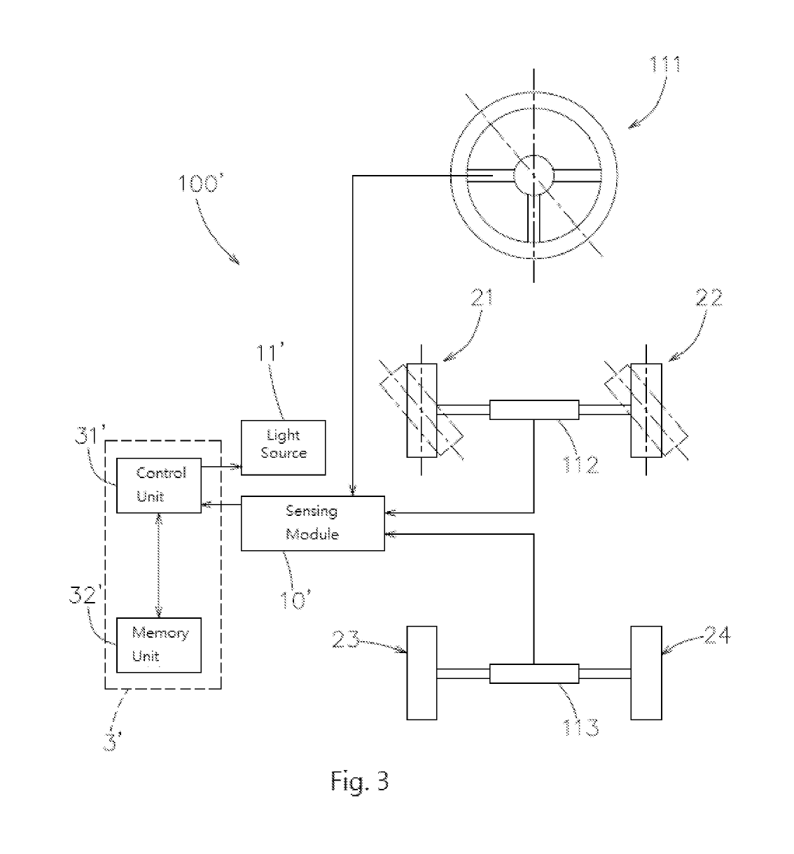

As shown in FIG. 3, light control apparatus 3′ comprises of a control unit 31′ and a memory unit 32′. The control unit 31′ is electronically connected with the sensing module 10′, light source 11′ and memory unit 32′. The control unit 31′, by the steering angle as sensed by the sensing module 10′ and other external control signals and referring to the pre-stored control command and data in memory unit 32′, can adjust light source 11′ into a variety of guide light beams associated with the turning angle of the vehicle. When vehicle 8 travels in the straight direction, it can adjust the light beam into the straight line guide light beam. When the vehicle 8 turns, it can adjust the light beams into a variety of curved guide light beams according to the turning angle. The aforementioned traveling directions comprise forward or backward traveling. With the forwarding guidance as an example, with the help of projecting the straight line guide light beam or curved guide light beam associated with the traveling direction in the front, on the side, below or on the windshield of the vehicle, the driver can clearly know the expected traveling trajectories when the vehicle is traveling straight and turning.

In the present invention of a traveling direction assistance guidance system 100′, the design principle of a laser projector can be used for designing the light source 11′ and control unit 31′; its interior may also comprise multi-color laser beam modulator(PCAOM), light pattern multiplexer, dichroic mirrors, X-Y scanner and other components. X-Y scanner can control projecting direction of the laser beam. Based on the control principle of the laser projector, we can carry out the optimum design of the light beam patterns for the real traveling directions including straight traveling and turning of the vehicle.

In this embodiment, the commands and data pre-stored in memory unit 32′ may comprise: a mapping table of steering angle corresponding to the direction and curvature of the projection beam, a mapping table of traveling speed corresponding to the length and color of the projection beam, a command to control light beam pattern or a code of controlling light beam pattern. Said commands to control light beam pattern comprise: a light source color selection command, a light source luminance control command, a linear or planar light beam selection command, a projection angle compensation command, a beam end pattern command, or a projected image data or X-Y coordinate data.

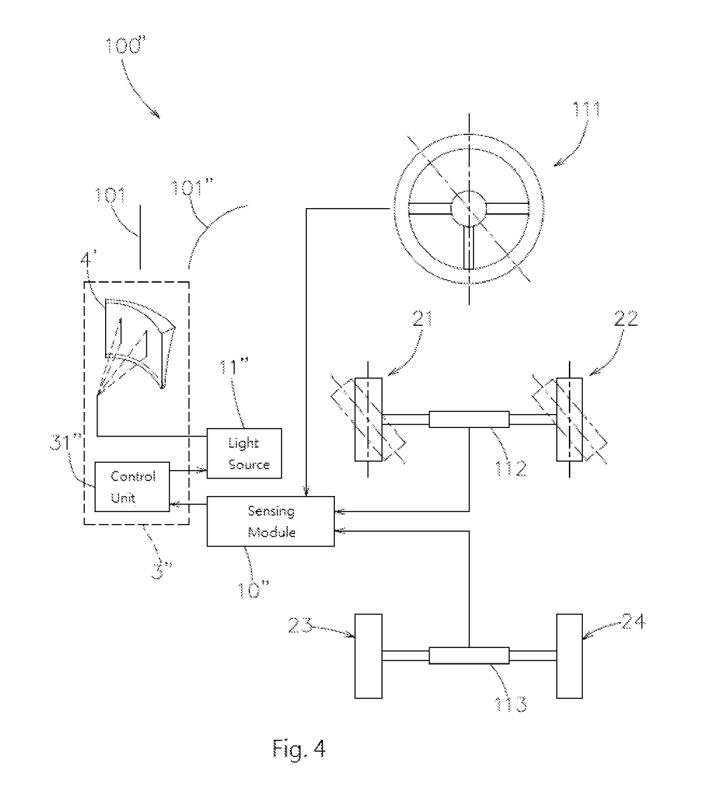

As shown in FIG. 4, in another embodiment of the present invention, traveling direction assistance guidance system 100″ comprises of a light source 11″, a sensing module 10″ and a light control apparatus 3″.

Sensing module 10″ is responsible of sensing the rotation angle of the steering wheel 111, the rotation angle of any drive module 112 or 113, the turning angle of any wheels 21, 22, 23, 24, or the rotation angle of any device linked with the aforementioned components. The light source 11″ provides a straight line light beam and the commonly used laser line generator can be used as the light source. Light control apparatus 3″ comprises of a control unit 31″ and a lens 4′. The control unit 31″, based on the steering angle sensed by the sensing module 10″ and other external control signals, to allow the straight line light beam of the light source 11″ to travel through a part of lens 4′ when the vehicle travels straight (not shown in the FIG.) and keep the light beam as a straight line guide light beam 101. When the vehicle turns, the straight line light beam of the light source 11″ can be adjusted into guide light beams 101″ of a variety of curvatures after traveling through the different parts of the lens.

To make the projected trajectory of light have different curvatures, the curvature or the refractive index of lens 4′ can be designed to change gradually from the lower layer to the upper layer according to the optical principles. After the adjustment of the lens of the incident longitudinal straight line light beam, the horizontal deflection of the upper beam will be greater than the lower beam, displaying the curved light beam. The greater difference in the curvature or refractive index between the upper and lower parts of the lens is, the greater curvature of the adjusted light beam will be. The differences vary at different parts of the lens. When the turning angle of the vehicle is greater, the part with greater difference will be used in adjustment of the light beam.

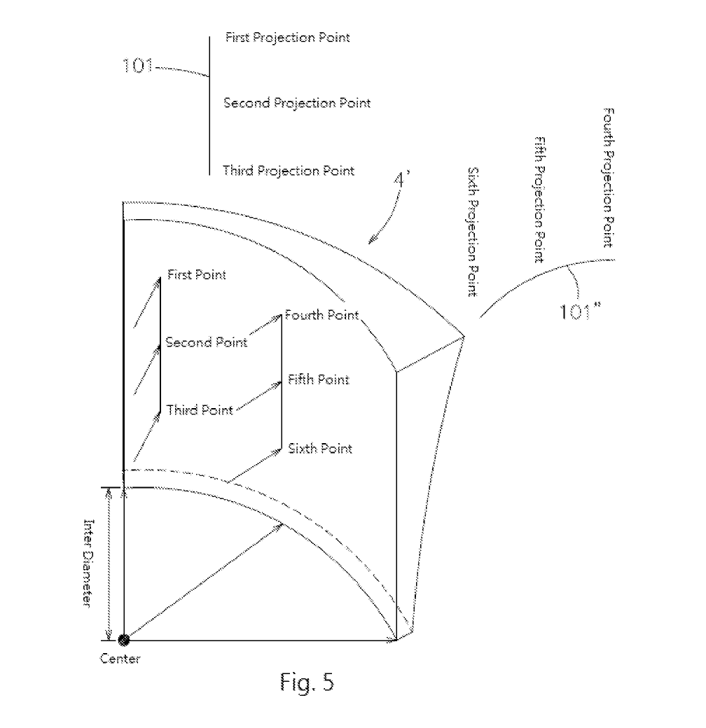

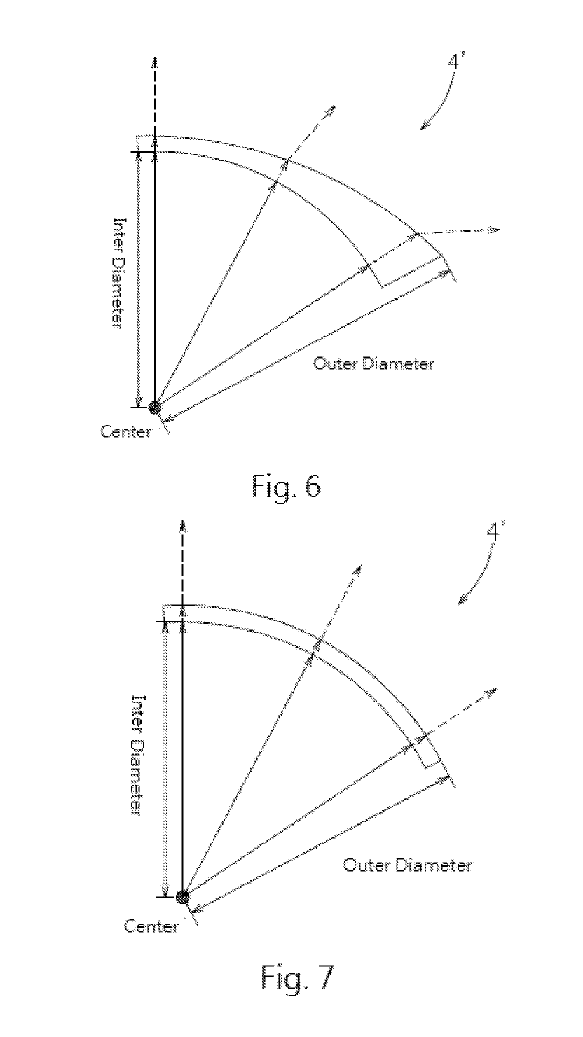

As illustrated from FIG. 5 to FIG. 7, the design of the upper layer of lens 4′ is that the internal curvature is different from the external one (as shown in FIG. 6), in other words, the internal diameter is fixed and the external diameter varies gradually. The design of the lower layer of lens 4′ is that the internal curvature is identical with the external curvature (as shown in FIG. 7). In this way, the curvatures of the upper and lower parts of lens 4′ will be different.

As shown in FIG. 5, after a straight line light beam (the line connecting the first, second and third points) going through lens 4′, the first projection point corresponding to the first point, the second projection point corresponding to the second point and the third projection point corresponding to the third point have no horizontal deflection, the line connecting the first projection point, the second projection point and the third projection point is still a straight line light beam; after another straight line light beam (the line connecting the fourth point, the fifth point and the sixth point) going through lens 4′, the horizontal deflection of the fourth projection point corresponding to the fourth point is the greatest followed by the horizontal deflection of the fifth projection point corresponding to the fifth point, and the horizontal deflection of the sixth projection point corresponding to the sixth point is the minimum. In this way, the line connecting the fourth projection point, the fifth projection point and the sixth projection point will display a curved light beam.

Moreover, lens 4′ can be a lens with multiple curvatures or refractive indices as mentioned above, it can also be designed as a combination of lenses of different curvatures or refractive indices. One lens component to keep the straight line light beam as a straight line guide light beam, and other lens components to adjust the straight line light beam into guide light beams of different curvatures.

In summary of the above, the benefits of the present invention of a traveling direction assistance guidance system 100, 100′, 100″ are: when driving vehicle 8, with the help of the projected line straight or curved light trajectories of the present invention of a traveling direction assistance guidance system 100, 100′, 100″, the driver can see clearly the expected traveling trajectories in the straight traveling and turning around of the vehicle 8 and thus effectively ensuring driving safety.

1. A traveling direction assistance guidance system for mounting on a vehicle, it is characterized that said guidance system comprising at least:
a light source for generating light beams;
a sensing module for sensing the traveling directions of the vehicle;
and a light control apparatus, based on the traveling direction of said vehicle sensed by said sensing module and other external control signals to adjust the light beams of said light source as the guide light beams associated with the traveling directions of said vehicle; when the vehicle travels straight, it can adjust the light beam of said light source as a straight line guide light beam; when said vehicle turns, the light beam of said light source can be adjusted as a curved guide light beam, and the direction and curvature of the guide light beams can change over the turning angle of the vehicle.

2. The guidance system as claimed in claim 1, wherein said vehicle comprises of a steering wheel adjusting said traveling direction of the vehicle, it is characterized that: said sensing module is a sensor detecting the rotation angle of said steering wheel or its linking device.

3. The guidance system as claimed in claim 2, wherein, it is characterized that: said light control apparatus comprises of at least a control unit and a memory unit; said control unit can adjust the light beam of said light source as a variety of patterns of guide light beam associated with the traveling direction of the vehicle based on the steering angle sensed by the sensing module and other external control signals coupled with control command and data recorded in said memory unit; said external control signals comprise the driver's selection of guide light beam types, or output signals of other devices for controlling the changes in the pattern of guide light beams.

4. The guidance system as claimed in claim 3, wherein, it is characterized that: the control commands and data pre-stored in said memory unit comprise a mapping table of turning angle corresponding to the direction and curvature of the projection beam, a mapping table of traveling speed corresponding to the length and color of the projection beam, a command to control light beam pattern or a code of controlling light beam pattern; said commands to control light beam pattern comprise a light source color selection command, a light source luminance control command, a linear or planar light beam selection command, a projection angle compensation command, a beam end pattern command, or a projected image data or X-Y coordinate data.

5. The guidance system as claimed in claim 1, wherein, it is characterized that: said light control apparatus comprising at least a lens and a control unit; said control unit, based on the steering angle sensed by the sensing module and other external control signals, control the light beam of light source going through a part of the lens into a straight line guide light beam of various patterns when the vehicle travels straight forward; and control the light beam of light source going through different parts of the lens into curved guide light beam of various patterns when the vehicle turns.

6. The guidance system as claimed in claim 5, wherein, it is characterized that: said lens is designed of a lens of curvature or refractive index of gradually changes from the lower layer to the upper layer according to the optical principles, so that the incident light beam differs in horizontal deflection in the upper and lower layers, showing a curved arc guiding light beams; when the curvature or refractive indices differences of the upper and lower layers of the lens are greater, the adjusted light beam curvature will be greater; the differences vary at different parts of said lens; when the turning angle of the vehicle is greater, the adjustment is made through the part of greater difference.

7. The guidance system as claimed in claim 5, wherein, it is characterized that: said lens is a lens with a variety of curvatures or refractive indices, or a plurality of lens components with different curvatures and refractive indices; among the assembly of lenses, a lens is to adjust the straight line guide light beam and the rest lens components adjust the curved guide light beams of different curvatures.
